(19) United States
(12) Patent Application Publication
(10) Pub. No.: US 2002/0165814 A1
(43) Pub. Date: Nov. 7, 2002

(54) System and method for ranking objects having multiple attributes

(76) Inventors: Juhnyoung Lee, Yorktown Heights, NY (US); Ho Soo Lee, Mount Kisco, NY (US)

Correspondence Address: McGuire Woods, LLP, 1750 Tysons Boulevard, Suite 1800, McLean, VA, 22102-3915, US

(21) Appl. No.: 09/848,428

(22) Filed: May 4, 2001

(51) Int. Cl. G06F 17/60

(52) U.S. Cl. 705/37

(57) ABSTRACT

A system and method that introduces ordering on a set of criteria and ranks alternatives having two or more attributes. More specifically, a system and method for online trading over a networked system where buyers and sellers make one or more trade deals on one or more products or services that have two or more attributes by using a Request For Quote (RFQ) process on an electronic marketplace. The system and method relates to decision under certainty. To provide the advantages presented by the system and method, a weight generator process computes weights of object attributes by re-engineering the ranks of the selected objects given by the user. The computing of the attribute weights is performed by score inequality.

### BACKGROUND OF THE INVENTION

1. Field of the Invention

The present invention generally relates to multi-criteria decision analysis that introduces ordering on a set of criteria and ranks alternatives having two or more attributes and, more particularly, to online trading over a networked system where buyers and sellers make one or more trade deals on one or more products or services that have two or more attributes by using a Request For Quote (RFQ) process on an electronic marketplace.

2. Background Description

Commerce over networks, particularly electronic commerce (e-commerce) over the Internet, has increased significantly over the past few years. Part of e-commerce enables buyers and sellers to make trades in one or more Web sites. Those Web sites are often referred to as electronic marketplaces, and provide one or more different forms of trading mechanisms including auction, reverse auction, and exchange. In an auction, one seller receives bids from one or more buyers for one or more products or services before making a transaction. In a reverse auction, one buyer receives bids from one or more potential sellers. In an exchange, multiple buyers and multiple sellers submit asks and bids, respectively, to a marketplace which makes matches between the asks and bids either continuously or periodically.

Request for Quotes (RFQ) is a type of reverse auction where a request is submitted by a buyer to an electronic marketplace to invite potential sellers to bid on specific products or services needed by the buyer's company or public agency. RFQ process is useful in all markets that depend upon multiple attributes, i.e., more than just price. RFQ process allows buyers to manually select one or more bids from sellers after examining and comparing submitted sell bids. RFQ process also allows for sellers to produce exactly what buyers want, leading to strong rate of return due to high satisfaction ratings.

There currently exist certain computer tools which may help buyers who use an RFQ process to evaluate and select one or more winning bids among all the submitted bids. One example is the scoring function of Perfect.com's™ RFQ engine. This tool allows a buyer, when submitting an RFQ, to specify the subjective importance of relevant factors of products or services such as quantity, material quality, product quality ratings, merchant reputation, warranty, support, delivery time, delivery cost as well as price. Then, after receiving bids from sellers, the RFQ engine filters the sell bids by using the buyer's criteria, calculating the scores of individual bids by using the buyer's profile and a scoring function, and ranking them by score. The buyer, when presented with the filtered sell bids with their ranks, selects winners among the bids. The use of bid ranking by score of individual sell bids helps buyer to select winners without going over lengthy unstructured text document describing product attributes and other factors relevant to purchase.

Techniques that may be used with e-commerce models may include, for example, Decision Theory, Decision under Certainty Decision under Risk.

### Decision Theory

Decision theory is a body of knowledge and related analytical techniques of different degrees of formality designed to help a decision maker choose among a set of alternatives in light of their possible consequences. Decision theory can apply to conditions of certainty, risk or uncertainty.

Decision theory recognizes that the ranking produced by using a criterion has to be consistent with the decision maker's objectives and preferences. This theory offers a rich collection of techniques and procedures to reveal preferences and to introduce them into models of decision. This technique, however, is not concerned with defining objectives, designing the alternatives or assessing the consequences; the theory usually considers them as given from outside or previously determined. Decision theory offers conceptually simple procedures for choice given a set of alternatives, a set of consequences, and a correspondence between those sets.

### Decision under Certainty

Decision under certainty means that each alternative leads to one and only one consequence, and a choice among alternatives is equivalent to a choice among consequences. In a decision situation under certainty, the decision maker's preferences are simulated by a single-attribute or multi-attribute value function that introduces ordering on the set of consequences and thus also ranks the alternatives. Simply, when probability distributions are unknown, one speaks about decision under uncertainty.

For the case of uncertainty, decision theory offers two main approaches. The first exploits criteria of choice developed in a broader context by game theory, as for example the max-min rule, where one can choose the alternative such that the worst possible consequence of the chosen alternative is better than (or equal to) the best possible consequence of any other alternative. The second approach is to reduce the uncertainty case to the case of risk by using subjective probabilities, based on expert assessments or on analysis of previous decisions made in similar circumstances.

### Decision under Risk

Decision under Risk means that each alternative will have one of several possible consequences, and the probability of occurrence for each consequence is known. Therefore, each alternative is associated with a probability distribution and a choice among probability distributions. Decision theory for risk conditions is based on the concept of utility. The decision maker's preferences for the mutually exclusive consequences of an alternative are described by a utility function that permits calculation of the expected utility for each alternative. The alternative with the highest expected utility is considered the most preferable.

### Problems With The Prior Art

One problem with the prior art is that it tends to be arbitrary, subjective and often extremely difficult for buyers to correctly and effectively assign importance value or “weight” to different attributes of a product or service. This fact is especially true when the buyer is not given any information about the algorithm of the scoring function, i.e., how the scoring function uses the weights of different attributes to generate a single score for different bids. It is possible, in many cases, that the score is assigned arbitrarily or in an unintended way. Known systems such as the scoring function of Perfect.com's™ RFQ engine simplifies the bid selection process for buyers in some cases. However, as a result of the problem described above, buyers may misjudge about submitted bids or need to examine lengthy unstructured text description on product/service attributes to understand and confirm the bid ranking given by such systems.

### SUMMARY OF THE INVENTION

An object of the present invention is to provide an improved system for decision making that introduces ordering on a set of criteria and ranks the alternatives having two or more attributes.

A further object of the present invention is to assists business application programs, including electronic marketplaces, to provide a decision making procedure for buyers of Request For Quote (RFQ) processes over a network that is used for evaluating submitted sell bids having two or more attributes.

In one aspect of the present invention, a computer system for ranking one or more objects having two or more attributes is provided. The computer system includes one or more visual interfaces which receives one or more objects having two or more attributes, and visually presents the one or more objects, as well as one or more weight generator modules which receives the one or more objects having two or more attributes and one or more objects ranked by one or more users, and computes one or more weights of one or more attributes of the objects. The system further includes one or more multi-criteria decision analysis module which receives the one or more objects having two or more attributes and one or more weights of one or more attributes of objects, and computes one or more scores of the one or more objects.

In another aspect of the present invention, a method is provided for ranking one or more objects having two or more attributes. The method includes receiving one or more objects having two or more attributes and specifying a number and members of the selected objects. The method further includes displaying one or more views of the selected objects in one or more visual interfaces as well as providing one or more ranks of the selected objects displayed in the one or more visual interfaces. Then, one or more weights of one or more attributes of the objects are computed by using one or more ranks specified for the selected objects. Also, one or more scores of one or more objects having two or more attributes is computed by using the computed weights of one or more attributes of objects. One or more views of the one or more objects with one or more scores for individual objects are displayed in the one or more visual interfaces. Displayed also are one or more weights of the one or more attributes of the objects in the one or more visual interfaces.

In another aspect of the present invention, a machine readable medium containing code for ranking one or more objects having two or more attributes is also provided. The code implements the steps of the method of the present invention.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a block diagram of a multi-criteria decision analysis procedure (module) in accordance with the present invention;

FIG. 2 is a sub-component used with the multi-criteria decision analysis system of the present invention;

FIG. 3 is a flow diagram of a multi-criteria decision analysis procedure (module) in accordance with the present invention;

FIG. 4 is another block diagram of a system architecture of an electronic marketplace in accordance with the present invention;

FIG. 5 is an example of an RFQ having multiple attributes;

FIG. 6 is an example of bids having multiple attributes;

FIG. 7 is an example of bid attribute weights;

FIG. 8 is an example of a subset view of bids with ranks;

FIG. 9 is an example of a full view of bids with scores; and

FIG. 10 is an example of bids with scores.

### DETAILED DESCRIPTION OF A PREFERRED EMBODIMENT OF THE INVENTION

The present invention relates to decision under certainty, and the use of multi-attribute value function to introduce ordering on a set of criteria and to rank alternatives having two or more attributes. As an application of the decision making procedure presented in accordance with the present invention, an example of online trading over the Internet where buyers and sellers make one or more trade deals on one or more products or services that have two or more attributes by using an Request For Quote (RFQ) process on an electronic marketplace is provided. However, the present invention should not be limited to this specific application, and can be adapted for use over any type of networked system.

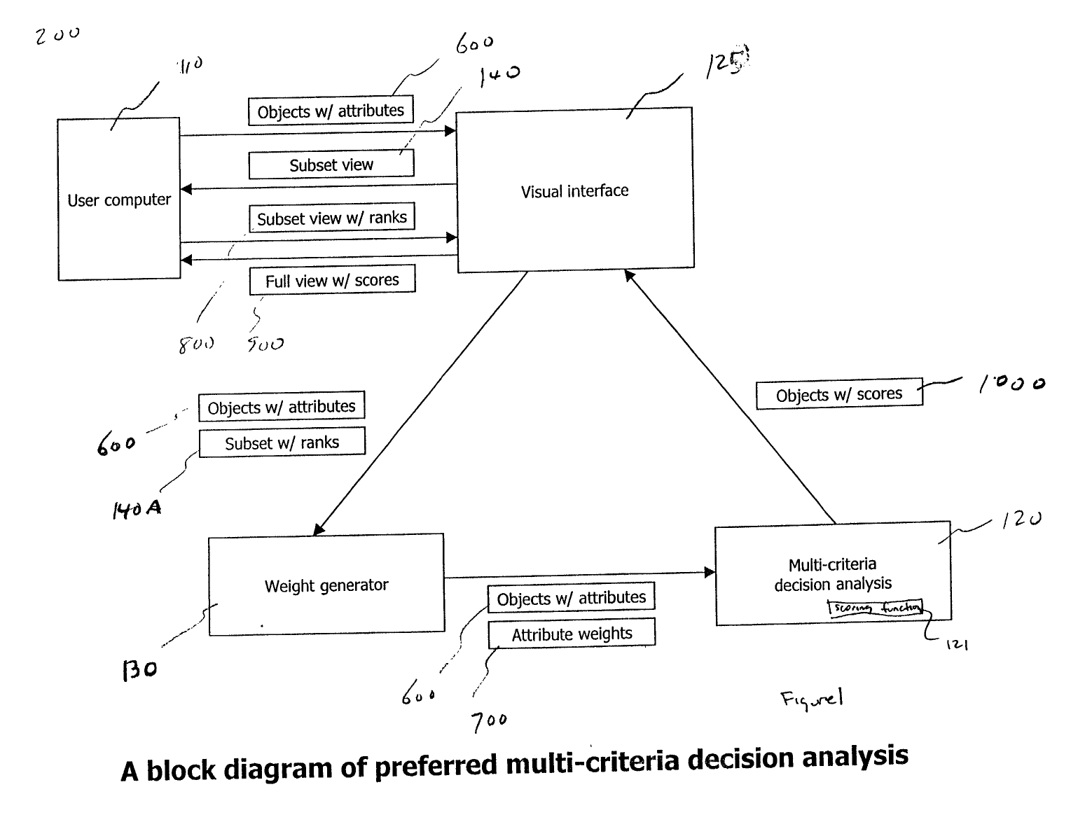

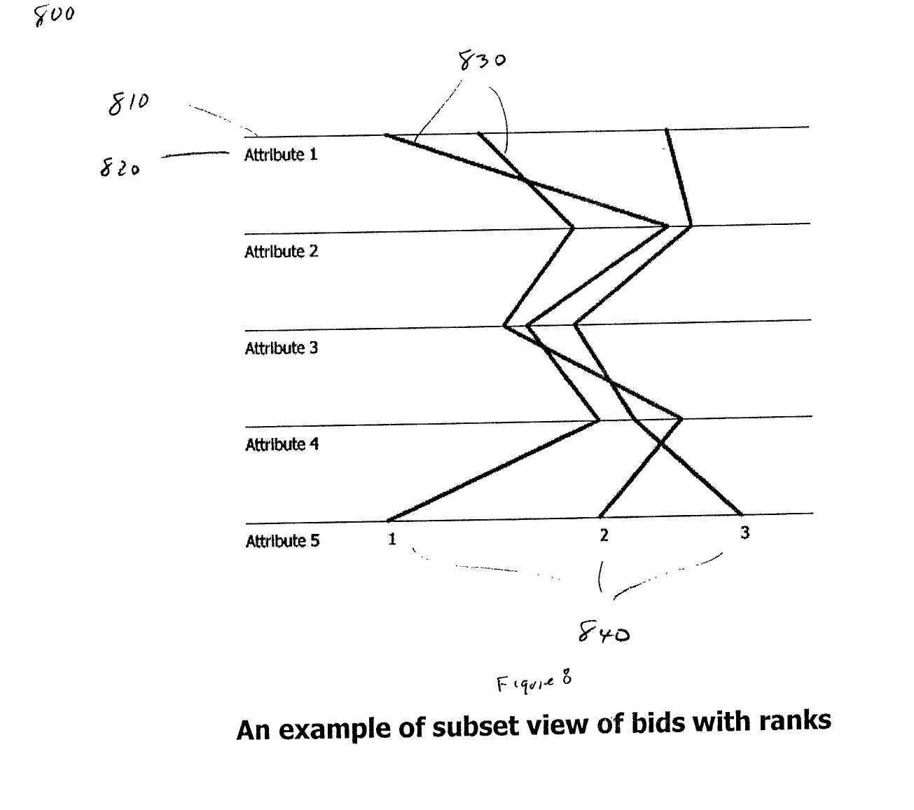

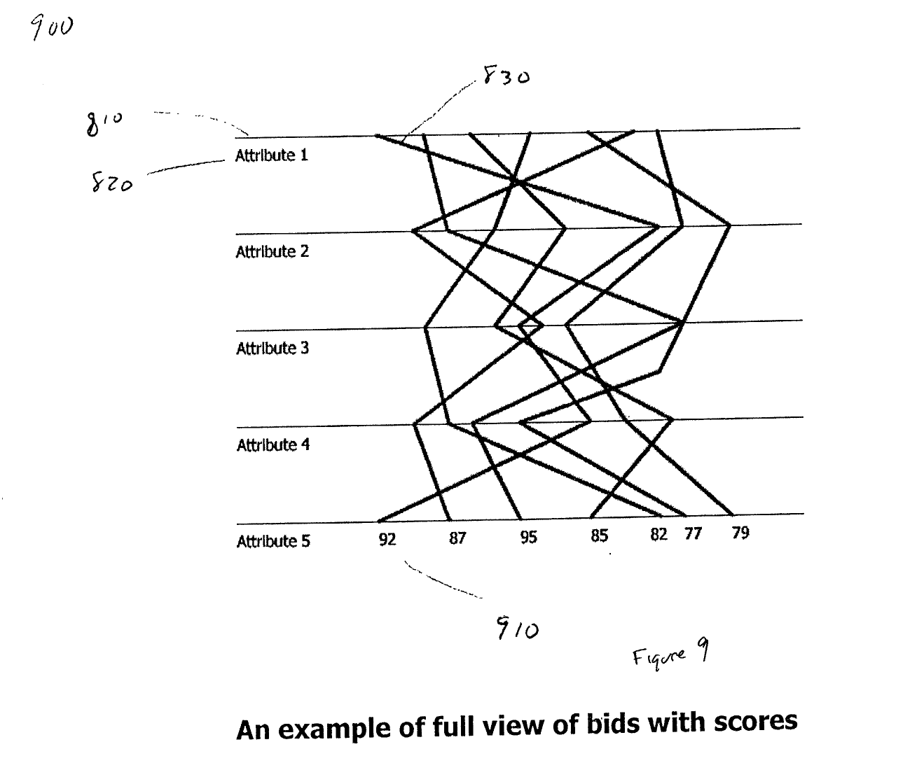

Referring now to the drawings, FIG. 1 shows a block diagram of a multi-criteria decision analysis system in accordance with the present invention. The procedure begins with only one piece of input, i.e., the set of objects with two or more attributes 600 (and without the set of attribute weights 700). The user submits the input of the object set 600 to the system by using a computer 110. Receiving the data set, the system visually presents the data in a computer screen by using the graphical user interface 125. The interface 125 allows the user to request one or more subsets of the input data 600 to be displayed; the user can specify the size of the subset and the selection of objects from the input data 600. Once the visual interface 125 presents the view of the subset of objects 140 in the computer screen, the visual interface 125 may also allow the user to manually rank the displayed objects on the screen. The ranks of the subset of the objects 800 is stored by the visual interface 125. Details of the views of objects (140, 800, and 900) in the visual interface 125 are discussed with reference to FIGS. 8 and 9.

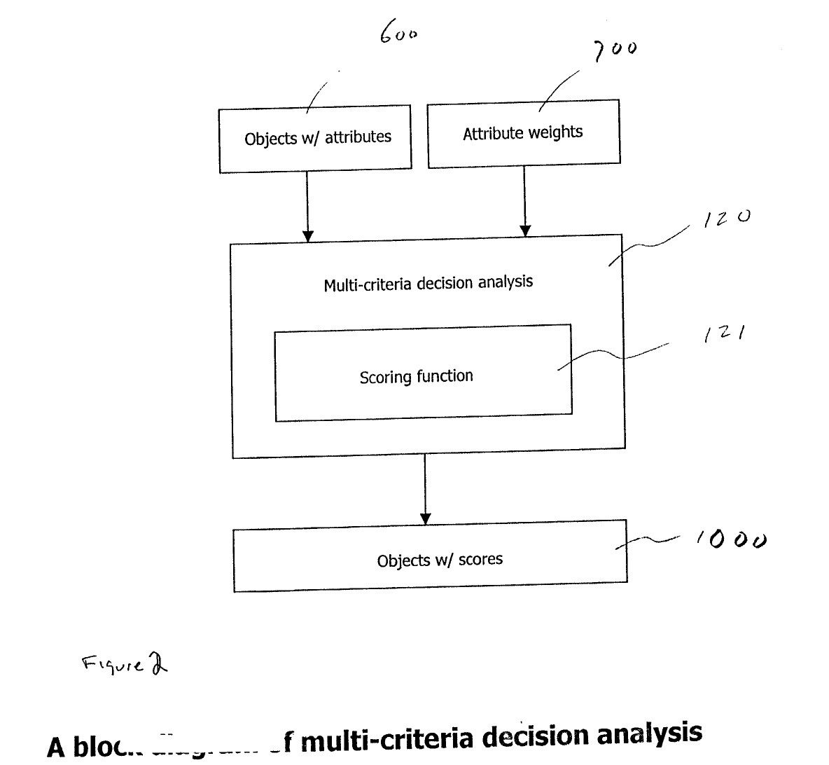

The interface 125 passes the information along with the initial input, i.e., the set of objects with two or more attributes, to the weight generator process 130. In turn, the weight generator process 130 computes weights of object attributes by re-engineering the ranks of the selected objects given by the user. The computing of the attribute weights is performed by score inequality. First, the system knows the score function 121 used by the multi-criteria decision analysis procedure (module) 120, i.e., Sᵢ=Σⱼwⱼf(aᵢⱼ). (The score function and the multi-criterial decision analysis 120 are discussed in detail with reference to FIG. 2 below). In this formula, the attribute values of the selected objects are known, i.e.,f(aᵢⱼ), as well as the ranks of the objects, i.e., whose score is greater than whose score, assuming that the better the rank, the greater the score. The exact scores of each of the selected objects are not known. Then, the score inequality is provided by using the following formula:

Σⱼwⱼf(a_{Aj})>Σⱼwⱼf(a_{Bj})>Σⱼwⱼf(a_{Cj}).

In this equation, the three scores are compared and the number of scores to be compared can be any number larger than 1, e.g., 2, 3, . . . By using the above formula, the system of the present invention can then identify one or more sets of attribute weights that satisfy this inequality. The solution from the weight generator process 130 is one of those sets.

The weight generator process 130 passes the computed attribute weights 700 along with the initial input of the set of objects with two or more attributes to the multi-criteria decision analysis process 120 which, in turn, computes the scores of the individual objects in the set 600 by using a scoring function 121 (discussed in more detail with reference to FIG. 2). The multi-criteria decision analysis process 120 passes the computed scores of the input objects 1000 to the visual interface 125 which then displays a view of the entire set of the input objects along with their scores 900 in the computer screen.

In the meantime, the visual interface may present the weights of the attributes 700 computed by the weight generator process 130 along with the object scores 900. The user examines the attribute weights 700 and the object scores 900. If the user believes that the attribute weights 700 and the object scores 900 are not accurate or not determined as the person intended, the user can then repeat the process, starting with a modification to the manual ranking of a subset of objects; that is, the user can change the subset of the selected objects 140 by adding and/or removing one or more objects and also changing the ranks of the selected objects.

FIG. 2 is a block diagram of the multi-criteria decision analysis procedure (module) 120 used with the present invention. The multi-criteria decision analysis 120 receives two pieces of input data: a set of objects 600 (where individual objects have two or more attributes) and a set of attribute weights 700 (where each weight specifies the importance of the corresponding attribute in decision making). Receiving the input data, the multi-criteria decision analysis procedure (module) computes the score of the input objects, one for each by using a scoring function 121 that takes into account the attribute values of individual objects 600 and the weights of attributes 700. An example of a scoring function 121 for the multi-criteria decision analysis procedure is a linear combination of the weighted values of the attributes, i.e.,

Sᵢ=Σⱼwⱼf(aᵢⱼ), for all i,

where Sᵢ denotes the score of object i, wⱼ the weight of the attribute j, aᵢⱼ the value of attribute j of object i, and f( ) a transformation of attribute value aᵢⱼ. The out of the multi-criteria decision analysis procedure is a set of objects with scores 1000, where each object in the input set 600 has a score given by the procedure.

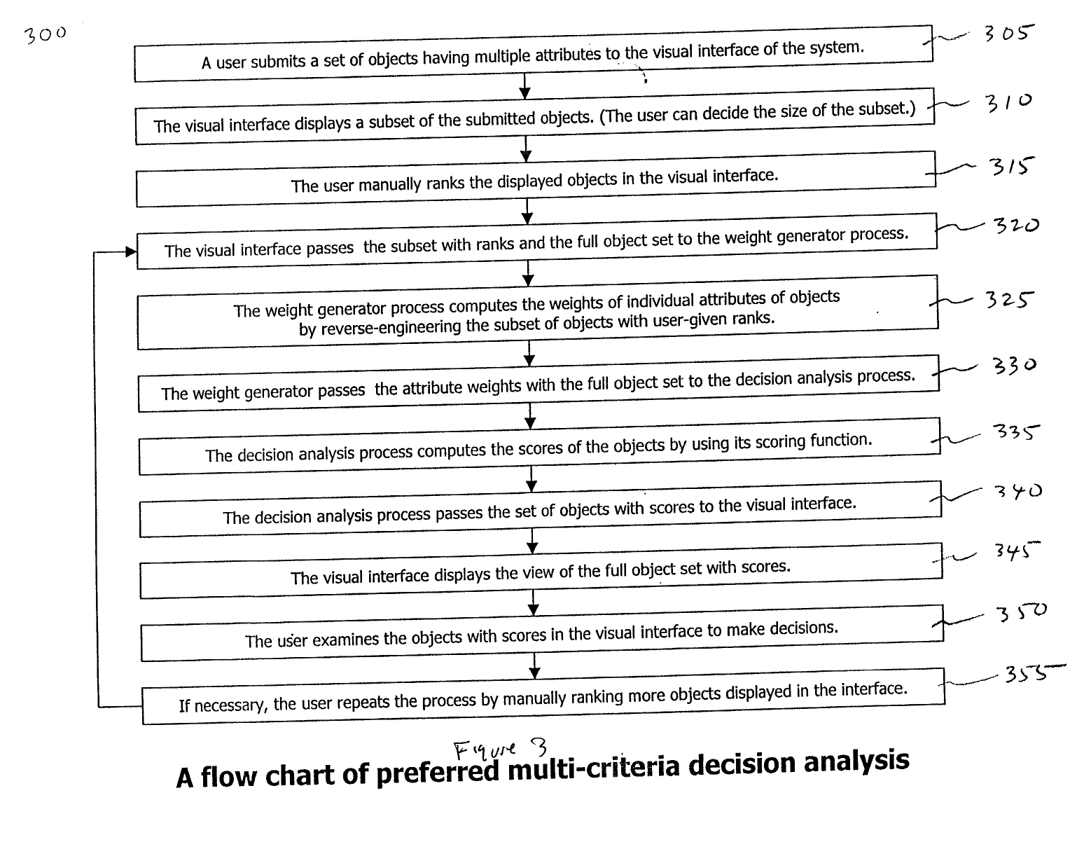

FIG. 3 is a flow chart implementing the steps of the multi-criteria decision analysis procedure of the present invention. FIG. 3 can equally represent a high level block diagram capable of implementing the steps provided therein. First, at step 305, a user submits a set of objects having two or more attributes 600 to the system by using the computer 110. Next, at step 310, after receiving the data set, the visual interface 125 graphically displays the object data in the computer screen. The interface 125 allows the user to display one or more subsets of the input data 600. Note that the user can specify the size of the subset and the selection of objects from the input data 600. At step 315, the system of the present invention allows the user to manually rank the displayed objects in the screen once the visual interface 125 presents the view of the selected objects 140. The ranks of the subset of the objects 800 is stored by the visual interface 125.

At step 320, the interface 125 passes the information along with the initial input, i.e., the set of objects with two or more attributes, to the weight generator process 130 after receiving the ranks of the selected objects 800 from the user (as discussed with reference to FIG. 1). At step 325, the weight generator process 130 computes the weights of object attributes 700 by re-engineering the ranks of the selected objects given by the user. At step 330, the weight generator process 130 passes the computed attribute weights 700 along with the initial input of the set of objects with two or more attributes to the multi-criteria decision analysis process 120. At step 335, the multi-criteria decision analysis process 120 computes the scores of the individual objects in the set 600 by using a scoring function 121. Then, at step 340, the multi-criteria decision analysis process 120 passes the computed scores of the input objects 1000 to the visual interface 125.

At step 345, the visual interface displays a view of the entire set of the input objects along with their scores 900 in the computer screen. In the meantime, the visual interface can present the weights of the attributes 700 computed by the weight generator process 130 along with the object scores 900. At step 350, the user examines the attribute weights 700 and the object scores 900. At step 355, if the user feels that the attribute weights 700 and the object scores 900 are not accurate or not determined as the person intended, the user can repeat the process starting with a modification to the manual ranking of a subset of objects. That is, the user can change the subset of the selected objects 140 by adding and/or removing one or more objects and changing the ranks of the selected objects. Finally, the user makes decisions on selecting one or more objects among the given set of objects by using the scores.

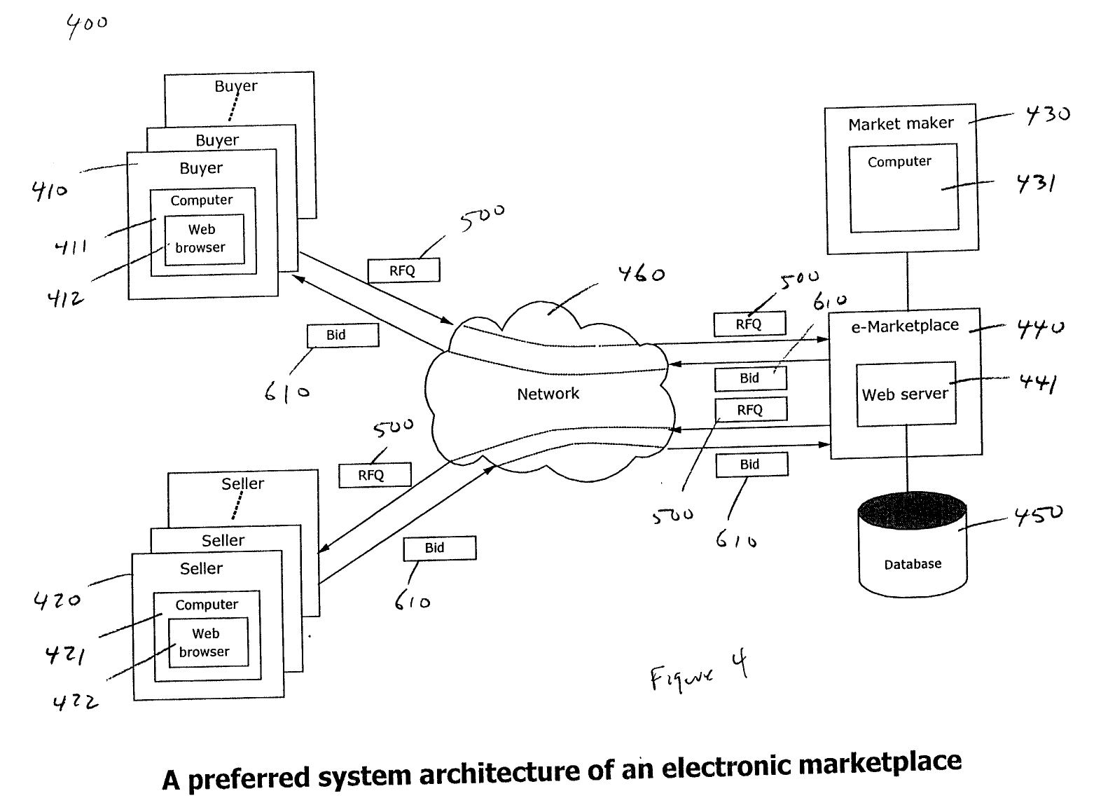

FIG. 4 is a block diagram of the system architecture of an e-marketplace. In FIG. 4, the architecture of the e-marketplace includes one or more buyers 410 accessing Web browser programs 412 via one or more computers 411. The buyers 410 submit Request for Quotations (RFQ) 500 via the web browser programs 412 over a network 460 to an e-marketplace 440 preferably implemented by a web server 441. The web server 441 stores the RFQ 500 as well as other information such as, for example, product catalogs, seller and buyer information and the like in a database system 450. A market maker 430 may operate the e-marketplace 440 via a computer 431. Once the RFQ 500 is submitted, the e-marketplace 440 will post the RFQ 500 on the web server 441.

Still referring to FIG. 4, one or more sellers 420 may access the e-marketplace 440 over the network 460 via a web browser program 422 residing on a seller computer 421. The web browser programs 412 and 422 as well as the web server 441 preferably use HyperText Transfer Protocol (HTTP). The sellers 420 may find and access the posted RFQ 500 via the web browser program 422, and thereafter submit one or more sell bids 610 having attribute values to the e-marketplace 440 via the network 460. The sell bid 610 and associated attribute values may be stored in the database 450 as well as transmitted to the buyer's web browser 412 over the network 460. Also, the web pages associated with both of the web browser programs 412 and 422 may provide a structured form for entering the appropriate information such as, for example, the RFQ and the submitted bids. The buyer 410 who made the RFQ 500 selects winners among the submitted sell bids 610.

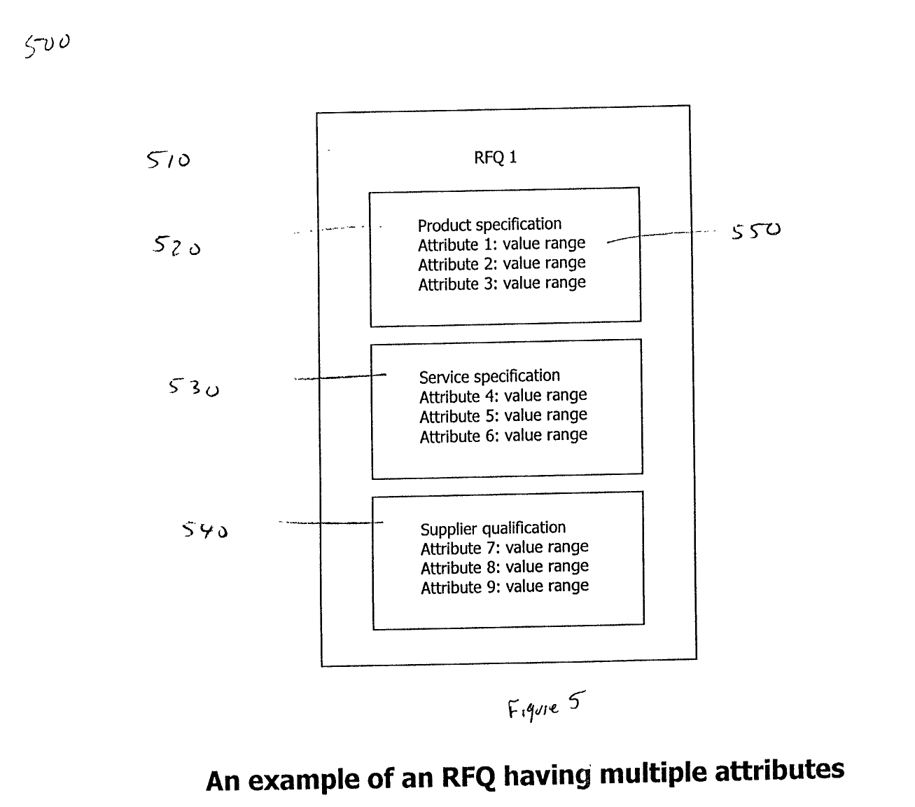

FIG. 5 is an example of an RFQ having multiple attributes. An RFQ is submitted by the buyer 410 to the electronic marketplace 440. An RFQ has an identification number 510 and comprises one or more attributes that may belong to one or more categories. Attributes are either numeric or categorical. Each attribute comprises a pair of name and value range 550. The value range of a numeric attribute specifies the lower and upper limits of desirable attribute values. On the other hand, the value range of a categorical attribute specifies the names that are acceptable for the category. In the example of FIG. 5, there are three attribute categories: (i) product specification 520 that includes attributes such as price, material quality and properties, color and size, (ii) service specification 530 that includes delivery time and cost and (iii) warranty and supplier qualification 540 that includes trading history, experience and reputation. Each category has three attributes.

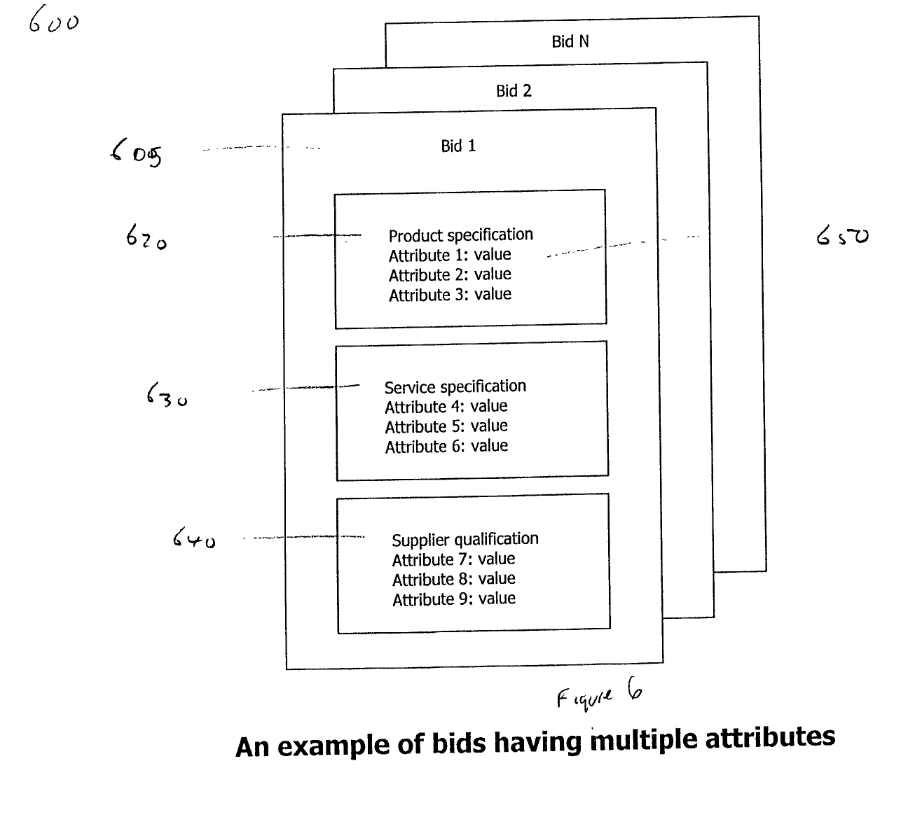

FIG. 6 is an example of bids having multiple attributes. Bids present an example of the set of objects having two or more attributes which is the input to the multi-criteria decision analysis system (in the context of decision making for selecting winning bids in online trading using RFQ process in electronic marketplaces). Bids are submitted by the sellers 420 to the electronic marketplace 440. The sell bid 610 has an identification number 605 and comprises one or more attributes and their values that are specified in the RFQ 500 in which this particular bid is submitted thereto. As in RFQ 500, attributes can be divided into several categories. Also, each attribute may comprise a name and value pair 650. In the example of FIG. 6, there are three attribute categories, i.e., product specification 620, service specification 630, and supplier qualification 640, each of which has three attributes.

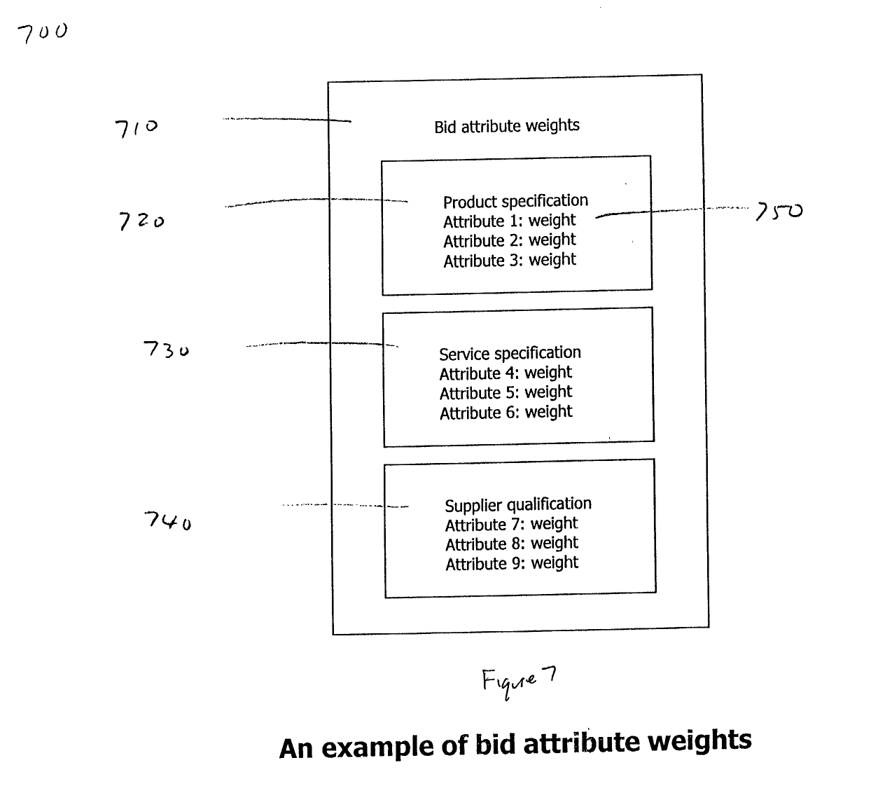

FIG. 7 is an examples of bid attribute weights which are a piece of input to the multi-criteria decision analysis procedures of both FIG. 1 and FIG. 2. The structure of the attribute weights is consistent with that of the RFQ 500 and a bid 610. The only difference is that in the attribute weights structure 700, a weight is given to each and every attribute. The attribute weights are used by the scoring function 121 to compute the score of each object, i.e., bid.

FIG. 8 is an example of a subset view of bids with ranks shown in the visual interface 125. The visual interface 125 may use a parallel coordinate system to present the set of objects having two or more attributes. An attribute is represented by a parallel axis 810 in the coordinate system. Each parallel axis, i.e., attribute line 810, is labeled by the name of the attribute 820. Also, an attribute value of an object is represented by a point on the corresponding parallel axis. Furthermore, an object 830 is represented by a collection of line segments that connect the attribute values of the object located on parallel axes. In the example of FIG. 8, there are five attributes of objects labeled as Attribute 1, 2, . . . , 5, and three objects 830 presented in the parallel coordinate system. The interface 125 allows the user to manually specify the ranks of the displayed object lines. In this example, the user specified the ranks of the objects in the interface by Number 1, 2, and 3 (840). The ranks of the selected objects given by the user are stored by the system of the present invention, and passed to the weight generator process 130 for calculating the weights of attributes.

FIG. 9 is an example of a full view of bids with scores shown in the visual interface 125. As previously discussed, the view is presented in a parallel coordinate system displaying attributes by parallel axes 810 and objects by polygonal lines 830. Unlike the subset view presented in FIG. 8, the display shown in FIG. 9 displays each and every object in the object set 600 input to the multi-criteria decision analysis system. In addition, this view displays the scores of the objects computed by the scoring function 121 of the multi-criteria decision analysis system 120. In the example of FIG. 9, there are five attributes of objects labeled as Attribute 1, 2, . . . , 5, and seven objects 830 whose scores range between 77 and 95 presented in the parallel coordinate system.

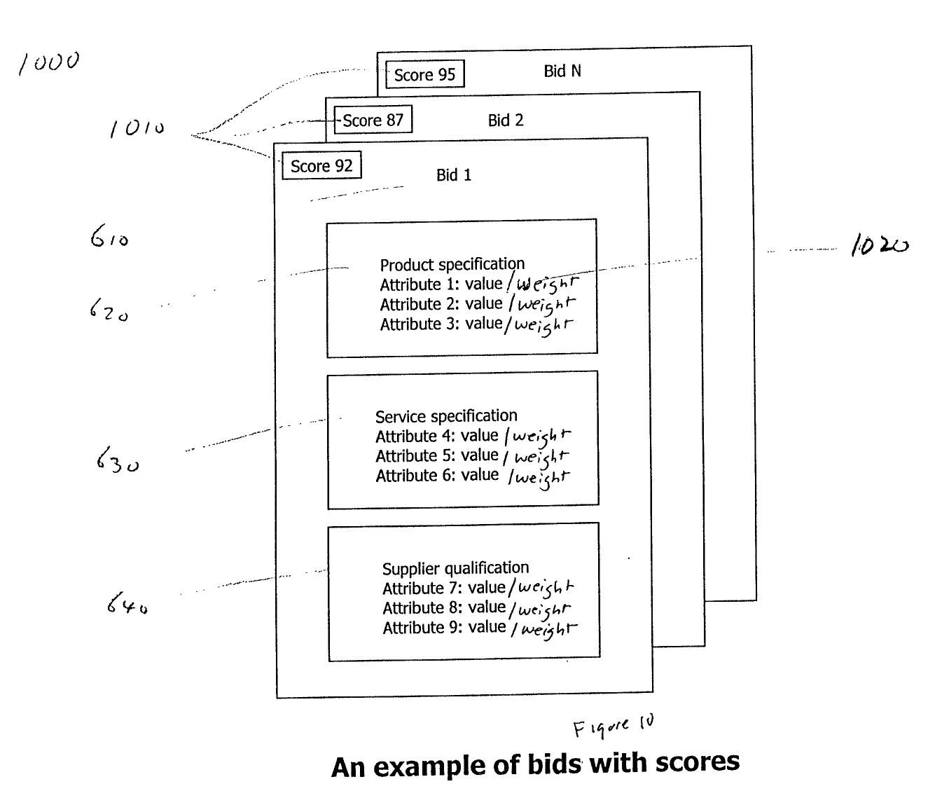

FIG. 10 is an example of bids with scores which are the output of the multi-criteria decision analysis procedures given in FIGS. 1 and 2. The structure of this output is consistent with that of the bid set 600. However, this structure presents a score for each bid 1010, and also presents a value and weight for each attribute 1020. This data structure is passed to the visual interface 125, which visualizes this data structure in a parallel coordinate system as shown in FIG. 9.

While the invention has been described in terms of preferred embodiments, those skilled in the art will recognize that the invention can be practiced with modification within the spirit and scope of the appended claims.

Having thus described our invention, what we claim as new and desire to secure by Letters Patent is as follows:

1. A computer system for ranking one or more objects having two or more attributes comprising:
one or more central processing units (CPUs) and one or more memories and one or more network interface to one or more networks associated with the CPUs;
one or more visual interfaces which receives one or more objects having two or more attributes, and visually presents the one or more objects;
one or more weight generator modules which receives the one or more objects having two or more attributes and one or more objects ranked by one or more users, and computes one or more weights of one or more attributes of the objects; and
one or more multi-criteria decision analysis module which receives the one or more objects having two or more attributes and one or more weights of one or more attributes of objects, and computes one or more scores of the one or more objects.

2. The system of claim 1, wherein at least one of the one or more objects having two or more attributes include a sell bid used in online trading based on one or more Request-For-Quote (RFQ) processes in marketplaces.

3. The system of claim 2, wherein the one or more attribute is a pair of name and value, and is grouped into categories including product specification, service specification and supplier qualification.

4. The system of claim 3, wherein the product specification includes attributes such as price, material quality and properties, color and size.

5. The system of claim 3, wherein the service specification includes delivery time and cost, and warranty.

6. The system of claim 3, wherein the supplier qualification includes trading history, experience and reputation.

7. The system of claim 1, wherein the visual interface presents a view of the one or more objects having two or more attributes in one or more parallel coordinates.

8. The system of claim 7, wherein the parallel coordinates presents an attribute of an object by a parallel axis labeled by attribute name, and the object having two or more attributes by a collection of line segments connecting attribute value points located on the parallel axes representing attributes.

9. The system of claim 1, wherein the visual interface allows one or more user to manually specify the ranks of the one or more objects having two or more attributes displayed in the visual interface.

10. The system of claim 1, wherein the visual interface presents a view of the one or more objects having two or more attributes along with the one or more scores of individual objects of the one or more objects.

11. The system of claim 1, wherein the visual interface presents a view of one or more objects having two or more attributes along with one or more scores of individual objects of the one or more objects and one or more weights of one or more attributes of objects.

12. The system of claim 1, wherein the score of the object having two or more attributes is a linear combination of one or more weighted attribute values of the object.

13. The system of claim 1, wherein the weight generator process computes one or more weights of one or more attributes of the object by using a score inequality specified by two or more ranks of one or more objects given by one or more users.

14. The system of claim 1, wherein:
the score inequality is provided by:
Σⱼwⱼf(a_{Aj})>Σⱼwⱼf(a_{Bj})>Σⱼwⱼf(a_{Cj}); and
a scoring function for calculating the scores is a linear combination of the weighted values of the attributes provided by:
Sᵢ=Σⱼwⱼf(aᵢⱼ), for all i,
wherein the number of scores can be any number larger than 1 and
wherein Sᵢ denotes a score of object i, wⱼ a weight of the attributed j, aⱼ a value of attribute j of object i, and f( ) a transformation of attribute value aⱼ.

15. A method of ranking one or more objects having two or more attributes comprising the steps of:
receiving one or more objects having two or more attributes;
specifying a number and members of the selected objects;
displaying one or more views of the selected objects in one or more visual interfaces;
providing one or more ranks of the selected objects displayed in the one or more visual interfaces;
computing one or more weights of one or more attributes of the objects by using one or more ranks specified for the selected objects;
computing one or more scores of one or more objects having two or more attributes by using the computed weights of one or more attributes of objects;
displaying one or more views of the one or more objects having two or more attributes with one or more scores for individual objects in the one or more visual interfaces; and
displaying one or more weights of the one or more attributes of the objects in the one or more visual interfaces.

16. The method of claim 15, further comprising the step of examining the one or more scores of one or more objects having two or more attributes for decision-making in selecting one or more objects having one or more high scores.

17. The method of claim 15, further comprising the step of examining the one or more weights of one or more attributes of objects for inspecting the accuracy of one or more weights of one or more attributes computed by one or more weight generator processes.

18. The method of claim 15, further comprising the step of changing a size and members of the selected objects having two or more attributes, and also changing one or more ranks of the selected objects.

19. The method of claim 15, further comprising repeating the steps of claim 15.

20. A machine readable medium containing code for ranking one or more objects having two or more attributes, the code implementing the steps of:
receiving one or more objects having two or more attributes;
specifying a number and members of the selected objects;
displaying one or more views of the selected objects in one or more visual interfaces;
providing one or more ranks of the selected objects displayed in the one or more visual interfaces;
computing one or more weights of one or more attributes of the objects by using one or more ranks specified for the selected objects;
computing one or more scores of one or more objects having two or more attributes by using the computed weights of one or more attributes of objects;
displaying one or more views of the one or more objects having two or more attributes with one or more scores for individual objects in the one or more visual interfaces; and
displaying one or more weights of the one or more attributes of the objects in the one or more visual interfaces.
